(19) United States
(12) Patent Application Publication
(10) Pub. No.: US 2003/0134628 A1
(43) Pub. Date: Jul. 17, 2003

(54) On a mobile device

(76) Inventor: Louis Robert Litwin, Plainsboro, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/047,269

(22) Filed: Jan. 15, 2002

(51) Int. Cl. H04M 3/00

(52) U.S. Cl. 455/419; 455/418

(57) ABSTRACT

In a mobile device wherein database update information is obtained by a user of the mobile device browsing the Internet in real-time, a method is provided for obtaining database update information by a mobile device The user is provided with an option of receiving the database update information in a background process performed on the mobile device (305). The database update information is automatically received through a low-bandwidth transmission in accordance with a refresh rate specified by the user, when the option is selected by the user.

### BACKGROUND

1. Technical Field

The present invention generally relates to mobile communications and, in particular, background updates for database information on a mobile device.

2. Background Description

Mobile devices such as cell phones have the ability to allow the user to request and view information such as e-mail, stock quotes, weather, news, and so forth. Such information typically corresponds to a database which is updated periodically with new or modified information. Accordingly, the information is hereinafter referred to herein as “database update information”. The information is generally received by browsing the Internet.

However, current Internet browsing on mobile devices is slow. Moreover, current Internet browsing ties up a phone connection so that the user cannot make or receive other calls.

Accordingly, it would be desirable and highly advantageous to have a method and apparatus for receiving database update information which is not slow. Moreover, it would be desirable and highly advantageous to have a method and apparatus for receiving database update information that does not tie up a phone connection and prevent a user of the mobile device from sending or receiving other calls.

### SUMMARY OF THE INVENTION

The problems stated above, as well as other related problems of the prior art, are solved by the present invention, background updates for database information on a mobile device.

Advantageously, the present invention allows a mobile device (e.g., a cell phone) to receive database update information (e.g., e-mail, weather, news, stock quotes) into the mobile device in the background via a low-bandwidth transmission. The information is “pushed” into the device from the network service provider using either unicast or multicast, depending on the type of information. This information is then cached on the phone. When the user goes to browse the web, the user can quickly view this information from the cache. This allows for fast browsing and efficiently uses system bandwidth by downloading via a low-bandwidth transmission. The trade-off is that the information is delayed. However, the delay (1 hour, 30 minutes, 10 minutes, and so forth) may be specified by the user, depending on the user's needs and other parameters.

According to an aspect of the present invention, in a mobile device wherein database update information is obtained by a user of the mobile device browsing the Internet in real-time, a method is provided for obtaining database update information by a mobile device. The user is provided with an option of receiving the database update information in a background process performed on the mobile device. The database update information is automatically received through a low-bandwidth transmission in accordance with a refresh rate specified by the user, when the option is selected by the user.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system 100 to which the present invention may be applied according to an illustrative embodiment thereof;

FIG. 2 is a block diagram illustrating a communication system 200 to which the present invention may be applied, according to an illustrative embodiment of the present invention;

FIG. 3 is a flow diagram illustrating a method for providing a mobile device with information, according to an illustrative embodiment of the present invention; and

FIG. 4 is a flow diagram illustrating a method for providing information to a mobile device, according to another illustrative embodiment of the present invention.

### DETAILED DESCRIPTION OF PREFERRED EMBODIMENTS

The present invention is directed to background updates for database information on a mobile device.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

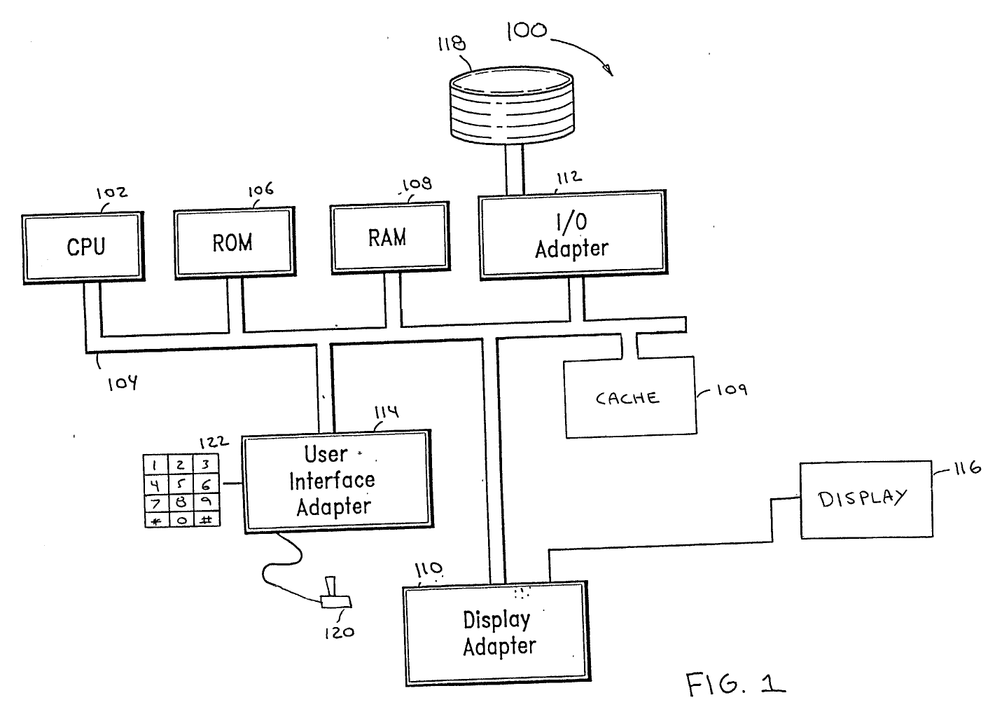

FIG. 1 is a block diagram of a computer processing system 100 to which the present invention may be applied according to an illustrative embodiment thereof. The computer processing system 100 includes at least one processor (CPU) 102 operatively coupled to other components via a system bus 104. A read only memory (ROM) 106, a random access memory (RAM) 108, a cache 109, a display adapter 110, an I/O adapter 112, and a user interface adapter 114 are operatively coupled to the system bus 104. A display device 116 is operatively coupled to the system bus 104 by the display adapter 110. A disk storage device (e.g., a magnetic or optical disk storage device) 118 is operatively coupled to the system bus 104 by the I/O adapter 112.

A selection device (e.g., mouse, joystick, and so forth) 120 and keyboard 122 are operatively coupled to the system bus 104 by the user interface adapter 114. The selection device 120 and keyboard 122 may be used to input/output information to/from the computer processing system 100.

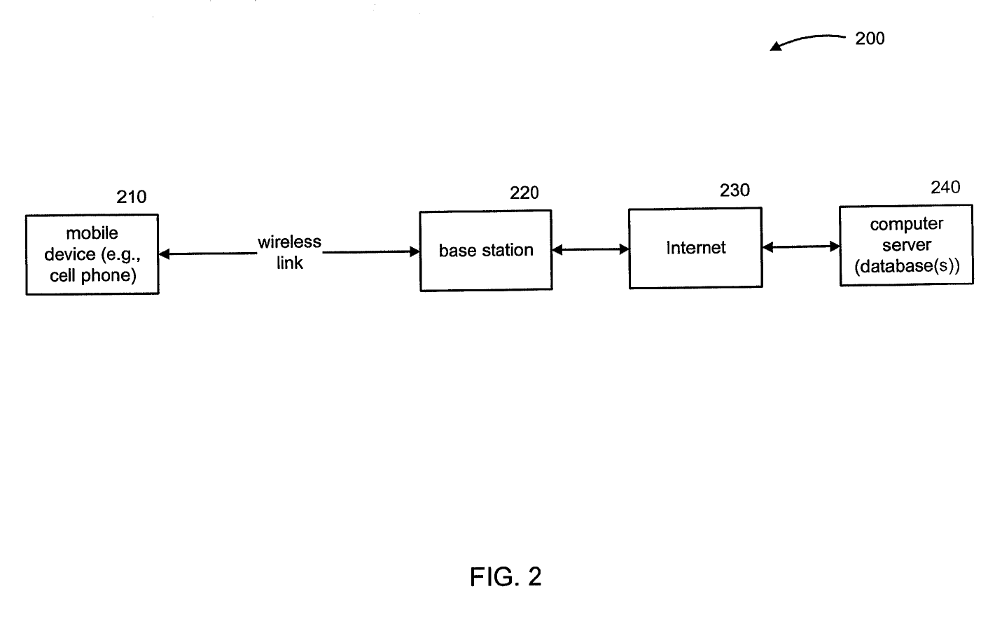

FIG. 2 is a block diagram illustrating a communication system 200 to which the present invention may be applied, according to an illustrative embodiment of the present invention.

It is to be appreciated that many of the elements of the communication system 200 will have a computer processing system integrated therewith. Such a computer processing system is preferably the same or similar to (having one or more of the same or similar elements) that shown in FIG. 1. However, other variations of a computer processing system may be readily employed by one of ordinary skill in the related art, while maintaining the spirit and scope of the present invention.

The communication system 200 includes a communication path formed by the following: a mobile device of a user (hereinafter also referred to as “user mobile device”) 210; a base station 220; the Internet 230; and a computer server 240. The computer server 240 includes one or more databases. It is to be appreciated that while one computer server is shown in FIG. 2 so to simplify the figure and accompanying description, one of ordinary skill in the related art will readily realize that the Internet is coupled to significantly more than one computer server.

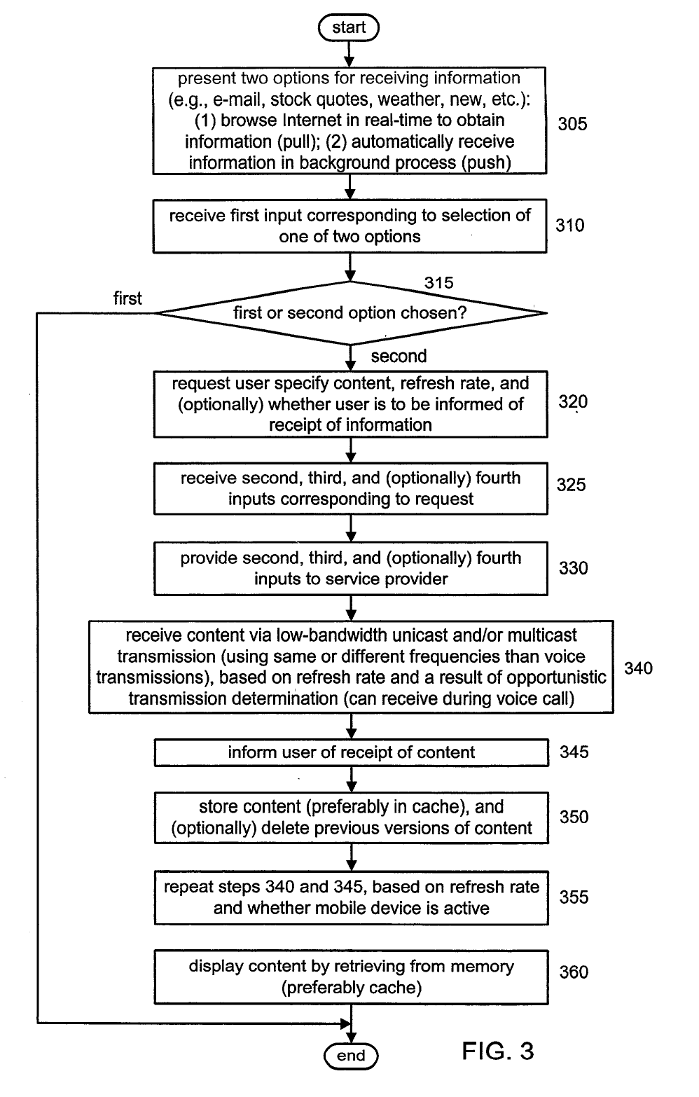

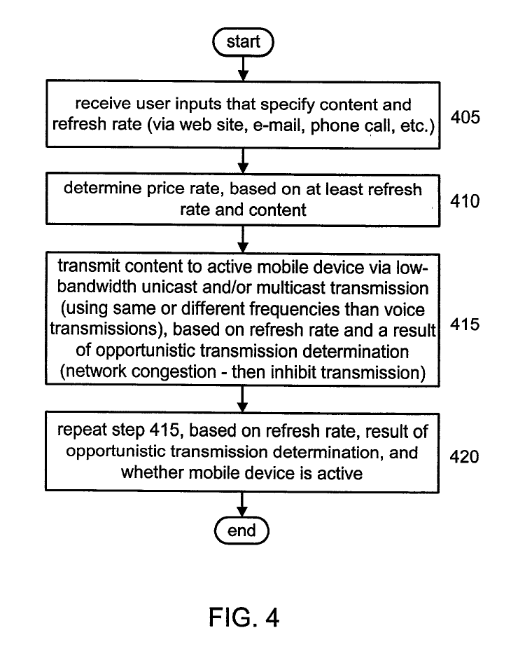

FIG. 3 is a flow diagram illustrating a method for providing a mobile device with information, according to an illustrative embodiment of the present invention. The method of FIG. 3 describes the steps performed with respect to the mobile device, in contradistinction to the method of FIG. 4 below, which describes the steps performed with respect to a service provider of the mobile device. It is presumed that the mobile device (e.g., a cellular phone) has the capability to receive the information (e.g., e-mail, stock quotes, weather, news, and other information).

The user is presented with a choice between two options for receiving the information (step 305). The first option is what is conventionally done to receive such information, that being for the user to browse the Internet in real-time. For example, a new call is made with an Internet browser of the mobile device to get new stock quote information. Each time the user goes to a web page to get new information, the data is retrieved (typically a slow process) from the Internet. Current phones cache some menu pages, but the data (e.g., stock quotes, weather, news) must be retrieved in real-time. Thus, the data must be downloaded to the mobile device before it can be displayed. This makes browsing slow and uses the full bandwidth of the user's connection, but gives the user up-to-date data. In the first option, the mobile device is “pulling” the data from the service provider.

The second option is for the user to automatically receive the information in the background. In the second option, the service provider is “pushing” the information to the mobile device.

A first user input is received corresponding to a selection of either of the first or the second option by the user (step 310).

It is then determined whether the user chose the first or the second option, based on the first user input received at step 310 (step 315). If the user chose the first option, then the method is terminated.

However, if the user chose the second option, then the user is requested to specify the content to be downloaded to the mobile device, the refresh rate at which the content is to be downloaded, and whether the user is to be informed when the mobile device ultimately receives the content (step 320). The last item (inform user) is optional and, thus, may not be provided by the user.

A second user input, a third user input, and a fourth user input are received corresponding to the content, the refresh rate, and whether the user is to be informed when the mobile device ultimately receives the content, as requested per step 320 (step 325).

The second, third, and fourth user inputs are provided to a service provider (step 330). The second, third, and fourth user inputs may be provided to the service provider via a website, e-mail, or by talking to a service provider representative on the phone. An example of the content would be if the user wants to download the latest news stories from the CNN website and the stock quotes for a list of specific companies. An example of the refresh rate would be updating the content (e.g., news and stock quotes) on the mobile device every hour and updating the e-mail on the mobile device every half hour.

When the mobile device is active, the content is received by the mobile device based on the chosen refresh rate(s) (third input at step 325) and a result from an opportunistic transmission determination (as described below), using unicast and/or multicast technology (step 340). Preferably, the content is provided via a low-bandwidth transmission. A user's e-mail messages would be unicast since the e-mail messages are only meant for the user, however, several users might be requesting the same stock quotes or news, and this information can be multicast to all the users simultaneously to reduce network congestion.

An opportunistic transmission determination (per step 340) corresponds to a determination made by the service provider regarding the congestion level on the network through which the content is to be provided. That is, although the user specifies a refresh rate for the content, if the network is heavily congested, the service provider can decide not to transmit the information at that time. Instead, the service provider would wait until the congestion level dropped below some predetermined level before sending out the updates.

The user can be informed when the content (database update information) arrives on the mobile device, depending on fourth input at step 325 (step 345). A beep or other alert can be used. Step 345 is an optional step because, for example, if the updates occurred frequently, the alerts could be annoying.

The received content is stored on the mobile device, preferably in one or more caches (hereinafter “cache”) (step 350). Step 350 may optionally include the step of deleting any previous versions of the content.

Steps 340, 350 and (optionally) 345 are repeated, based on the chosen refresh rate (third input at step 325) and whether the mobile device is (still) active (step 355). Repetition of step 345 further depends on the fourth input at step 325.

Upon receiving a request from the user to display the content on the mobile device, the cached version of the content will be displayed (instead of going out over the network to download the latest data) (step 360). The advantage of this is that all of the information is resident in the mobile device's memory and hence the user can quickly browse through the content (e-mail messages, various web pages, and so forth) instead of waiting for each new page to load, and so forth. That is, when the user views the database information, such as the user's e-mail or weather information, the user would be viewing the latest cached version of the information. This means that the browsing from page to page could be done very quickly since the pages are taken from memory instead of from a slow Internet connection.

At any time when the mobile device is active, the user optionally logs onto a network to download information in real-time if the user so desires (instead of downloading the information in the background).

FIG. 4 is a flow diagram illustrating a method for providing information to a mobile device, according to another illustrative embodiment of the present invention. As noted above, the method of FIG. 4 describes the steps performed with respect to the service provider, in contradistinction to the method of FIG. 3 above, which describes the steps performed with respect to the mobile device.

User inputs are received from a user that specify the content to be downloaded to the mobile device and the refresh rate at which the content is to be downloaded (corresponding to the second and third user inputs) (step 405).

The price rate for providing services to the mobile device is determined based upon at least the refresh rate specified at step 405 (e.g., more frequent updates, higher price), and also is preferably based on the content specified at step 405 (e.g., more content, higher price) (step 410).

When the mobile device is active, the content is transmitted to the mobile device based on the chosen refresh rate(s) and a result from an opportunistic transmission determination (as described below), using unicast and/or multicast technology (step 415). Preferably, the content is provided via a low-bandwidth transmission. The content may be sent to the mobile device either using the same frequencies used for voice communications, or a dedicated frequency range. A user's e-mail messages would be unicast since the e-mail messages are only meant for the user, however, several users might be requesting the same stock quotes or news, and this information can be multicast to all the users simultaneously to reduce network congestion.

An opportunistic transmission determination (per step 415) corresponds to a determination made by the service provider regarding the congestion level on the network through which the content is to be provided. That is, although the user specifies a refresh rate for the content, if the network is heavily congested, the service provider can decide not to transmit the information at that time. Instead, the service provider would wait until the congestion level dropped below some predetermined level before sending out the updates.

Step 415 is repeated, based on the chosen refresh rate (third input at step 325), the result of the opportunistic transmission determination, and whether the mobile device is (still) active (step 420).

At any time when the mobile device is active, the user optionally logs onto a network to download information in real-time if the user so desires (instead of downloading the information in the background).

It is to be appreciated that the communications section of a mobile device implementing the present invention can have the following three modes: (1) off—the device is not transmitting or receiving; (2) receive only—the device is not sending information but the background updates can occur; and (3) transmit and receive—the user is making a call and data is being both transmitted and received.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method for obtaining database update information by a mobile device, comprising the steps of:
receiving the database update information through a low-bandwidth transmission in accordance with a refresh rate and a content selection previously specified by the user; and
displaying the database update information.

2. The method of claim 1, wherein at least a portion of said receiving step is performed using at least one of unicast technology and multicast technology.

3. The method of claim 1, further comprising the step of storing the content in at least one memory device of the mobile device.

4. The method of claim 3, wherein the at least one memory device comprises a cache.

5. The method of claim 1, further comprising the step of repeating said receiving step in accordance with the refresh rate.

6. The method of claim 1, wherein said receiving step is performed during a voice call from or to the mobile device.

7. The method of claim 1, wherein the database update information comprises at least one of e-mail, stock quotes, weather, and news.

8. The method of claim 1, wherein said receiving step is performed using at least one frequency that is different than that used for voice communications.

9. In a mobile device wherein database update information is obtained by a user of the mobile device browsing the Internet in real-time, a method for obtaining database update information by a mobile device, comprising the steps of:
providing the user with an option of receiving the database update information in a background process performed on the mobile device; and
automatically receiving the database update information through a low-bandwidth transmission in accordance with a refresh rate specified by the user, when the option is selected by the user.

10. The method of claim 9, wherein at least a portion of said receiving step is performed using at least one of unicast technology and multicast technology.

11. The method of claim 9, further comprising the step of storing the content in at least one memory device of the mobile device.

12. The method of claim 11, wherein the at least one memory device comprises a cache.

13. The method of claim 9, further comprising the step of repeating said receiving step in accordance with the refresh rate.

14. The method of claim 9, wherein said receiving step is performed during a voice call from or to the mobile device.

15. The method of claim 9, wherein the database update information comprises at least one of e-mail, stock quotes, weather, and news.

16. The method of claim 9, wherein said receiving step is performed using at least one frequency that is different than that used for voice communications.

17. The method of claim 9, further comprising the steps of:
receiving a user input requested that the user be informed when the database update information is received by the mobile device; and
informing the user that the mobile device has received the database update information, upon performing said receiving step.

18. A method for providing database update information to a mobile device, comprising the steps of:
receiving a first user input and a second user input corresponding to a refresh rate and a selection of the database update information, respectively; and
transmitting the database update information to the mobile device through a low-bandwidth transmission in accordance with a refresh rate and the selection.

19. The method of claim 18, wherein the first user input and the second user input are received via an e-mail communication from the user.

20. The method of claim 18, wherein the first user input and the second user input are received via user selections at a pre-designated web site.

21. The method of claim 18, wherein the first user input and the second user input are received via a specific phone call placed by the user.

22. The method of claim 18, further comprising the step of determining a service charge for services provided to the mobile device, based on at least the refresh rate.

23. The method of claim 18, further comprising the steps of:
determining whether a network congestion is above a predefined threshold; and
inhibiting said transmitting step irrespective of the refresh rate, when the network congestion is above the predefined threshold.

24. The method of claim 23, further comprising the step of repeating said transmitting step subsequent to said inhibiting step, when the network congestion is below the predefined threshold.
